(19) United States
(12) Patent Application Publication
(10) Pub. No.: US 2006/0131455 A1
(43) Pub. Date: Jun. 22, 2006

(54) Cone crusher

(76) Inventors: Jean-Pierre Delille, Romaneche-Thorins (FR); Serge De Backer, La Chapelle De Guinchay (FR); Michel Rude, Cenves (FR)

Correspondence Address: YOUNG & THOMPSON, 745 SOUTH 23RD STREET, 2ND FLOOR, ARLINGTON, VA, 22202, US

(21) Appl. No.: 11/083,991

(22) Filed: Mar. 21, 2005

(30) Foreign Application Priority Data
Dec. 17, 2004 (FR) 04 13491

(51) Int. Cl. B02C 2/00

(52) U.S. Cl. 241/207

(57) ABSTRACT

A cone crusher includes a truncated conical crushing chamber, whose wall supports a fixed jaw (1), and a conical head (2) mounted on a shaft coaxial with the chamber and provided with an eccentric. The eccentric carries the movable jaw (2). The spacing r between the jaws (1, 3), including the compensation for overall wear, is carried out when stopped, before working, by elements ensuring a vertical movement of the fixed jaw (1) relative to the frame (11), whilst the measures of adjustment, safety and daily wear compensation are adjusted, during working of the crusher, by at least one jack (7) located below the movable jaw (2) to provide to the latter a vertical movement.

The present invention relates to the adjustment of the spacing between the fixed jaw and the movable jaw of a cone crusher.

Cone crushers comprise a truncated conical crushing chamber, whose wall supports a fixed jaw, and a conical head carrying the movable jaw mounted on a shaft coaxial with the chamber. The geometrical axle of the conical head forms, with the summit of this latter, a certain angle with the axle of the drive shaft, which gives to the head, when the shaft turns, a nutatory movement. During its descent into the chamber, the materials are progressively crushed so as to reach the size of the smallest space r between the fixed jaw and the movable jaw, at the base of the head during nutation.

This spacing r must be adjusted for the granulometry to be obtained, before the beginning of crushing and during crushing.

A cone crusher thus has three functions for adjusting this spacing:

1—An initial adjustment of the spacing, which consists in adjusting the distance between the fixed jaw and the movable jaw, this distance ensuring the dimensions of the crushed products.

2—An adjustment to compensate for wear, which consists in bringing the jaws toward each other when they are worn in the course of working, so as to retain the initial adjustment, the spacing being increased because of wear.

There should be distinguished overall wear, and the daily wear.

The overall wear is the wear of the jaws having already served during crushing. It is compensated at the same time as the adjustment of the spacing, before starting the machine.

The daily wear is the progressive wear which takes place during working. This daily wear is compensated, in the course of working, by adjustment by means of a jack which moves one jaw upwardly or downwardly as the case may be, either automatically thanks to a control, or manually, where the measurement of the spacing indicates a variation of this latter.

3—A safety adjustment, which is to say protection of the machine against the passage of uncrushable pieces larger than the adjustment and which could damage it. It consists in rapidly spacing apart one from the other the two jaws to let this uncrushable item be discharged and then to return to the desired adjustment.

These functions have until now been fulfilled in two different ways, with two different types of machines:

1—The crushers of type 1 whose central portion (comprising the movable jaw) is fixed in vertical translation and whose upper portion (comprising the fixed jaw) is adjustable vertically and can retract upwardly thanks to a system of jacks or springs.

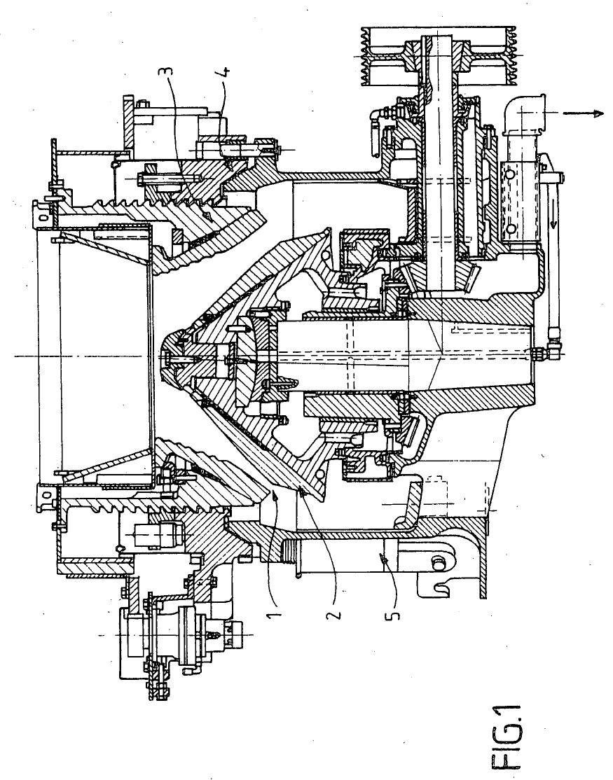

a first example of this type is shown in FIG. 1 in which the initial adjustment and the compensation adjustment for overall wear, are provided by screwing the bowl 3 into the ring 4, and the safety adjustment by raising the ring 4, and hence all the upper portion (including the fixed jaw) by means of jacks 5, to let uncrushable items escape.

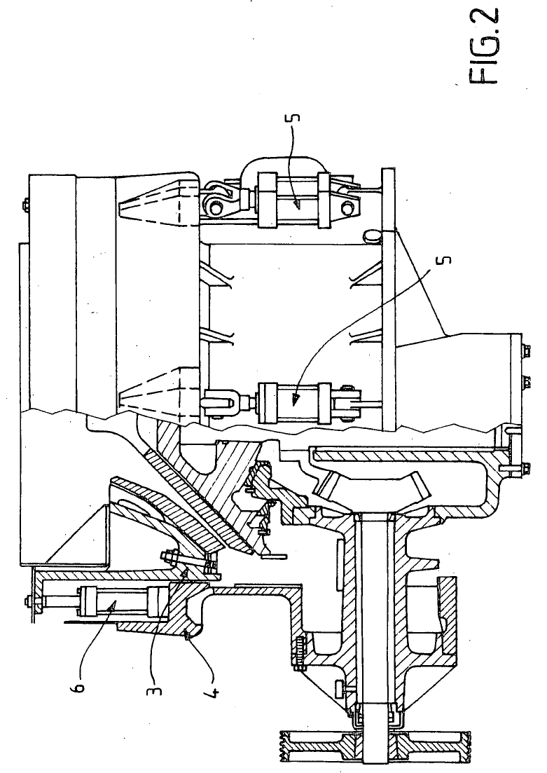

a second example is given in FIG. 2, in which the adjustment of the compensation for overall wear are ensured by the sliding of the bowl 3 in the ring 4 by means of jacks 6, safety being ensured in a similar manner to the preceding example, by jacks 5.

In these two cases, the wear is compensated at the beginning of each working phase, in general at the beginning of the day, by carrying out the initial adjustment of the spacing r, as in the case of new jaws.

The safety adjustment is ensured by means of accumulators provided at the determined working pressure to the jacks 5, as soon as the pressure transmitted by these jaws increases because of uncrushable material coming between them, and becomes greater than that of the accumulator, the jack raises the bowl 3 to increase the spacing between the jaws and let pass the uncrushable material.

The principal drawbacks of this type of construction are:

The high cost of the safety device comprising several jacks and accumulators.

The difficulty of adjusting the crusher when it is loaded and hence to compensate for daily wear, because the bowl must then be loosened, the bowl-ring connection being then subjected to shocks and vibrations due to crushing; this gives rise to mechanical damage to this connection.

2—The crushers of type 2 whose upper portion carrying the fixed jaw is fixed and whose central portion carrying the movable jaw is movable in vertical translation by means of one or several jacks placed therebelow.

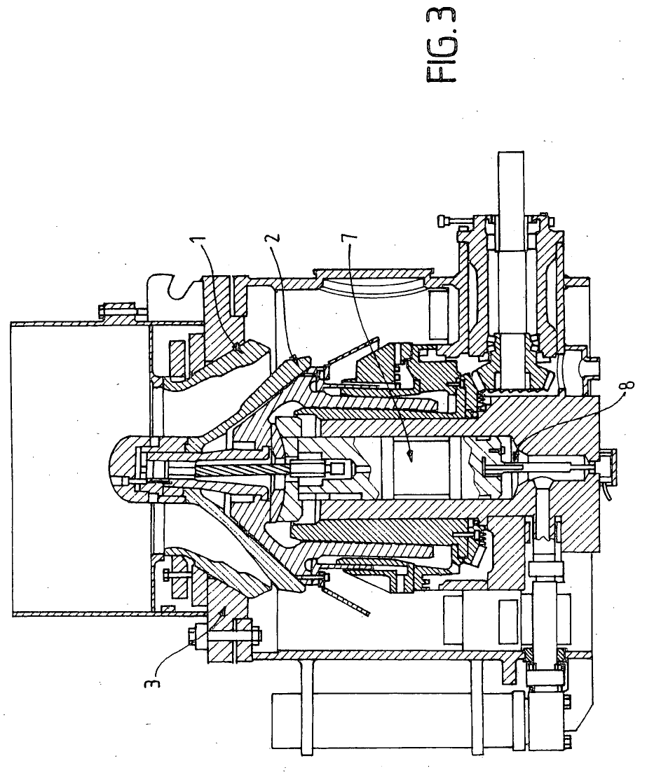

a first example of this type is given in FIG. 3: the fixed jaw 1 is held in a bowl 3 which is fixed to the frame. The movable jaw is supported by the shaft 7 which renders it movable in vertical translation under the action of the jack 8, this latter ensuring the 3 functions of initial adjustment, wear compensation, and safety.

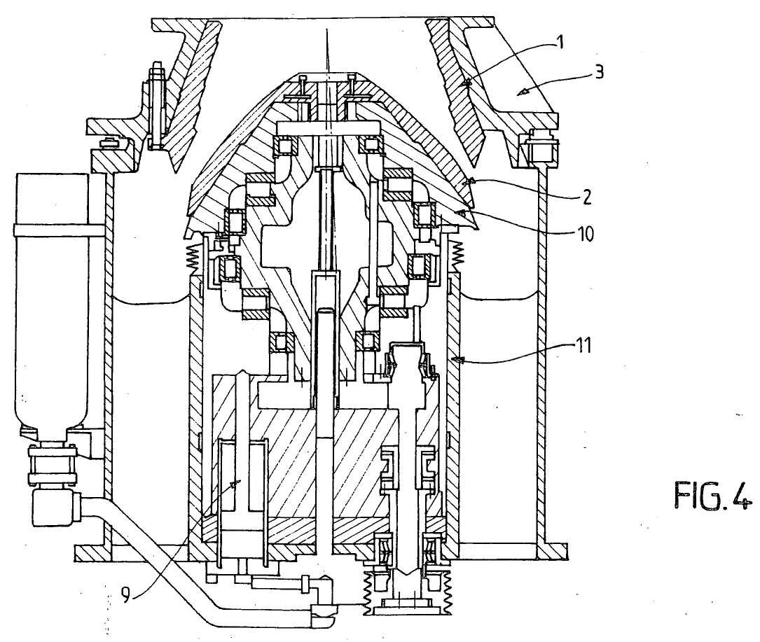

a second example is given in FIG. 4: the fixed jaw 1 is held in the bowl 3 which is fixed to the frame. The movable jaw is supported by the head 10 which slides in the frame 11 under the action of jacks 9, these latter ensuring the 3 functions of adjustment, wear compensation and safety.

As for the crushers of type 1, the jacks 8 and 9 are subject in normal operation to the pressure of an accumulator whose pressure is determined to let the jack work in the other direction in the case of overpressure, transmitted by the jaws.

The principal drawbacks of this type of construction are:

a great height of the machine due to the stages to be provided for the different functions. Thus, as soon as the work starts, it is necessary to give the jacks a minimum safety path to compensate the crushing forces greater than normal.

the difficulty of absorbing the crushing forces, given the total of the different courses, requires most if not all of the manufacturers to neglect safety measures when the jaws are new, the machine then being only very little protected against uncrushable materials before mid-wear of the jaws.

The invention consists in providing a crusher which has the advantages of the two types above, without having their drawbacks.

This consists in ensuring the measures of safety, adjustment and daily wear compensation, the crusher being loaded, by one or more jacks located below the movable jaw as in the crushers of type 2, and in ensuring the compensation of overall wear by vertical movement of the fixed jaw in the frame as in the crushers of type 1, this operation being executed during a stopped phase.

This object is achieved in that the adjustment of the spacing between the jaws, including the compensation for overall wear, is carried out when stopped, before working, by means ensuring a vertical movement of the fixed jaw relative to the frame, whilst the measures for adjustment, safety and daily wear compensation are adjusted, during working of the crusher, by means of at least one jack located below the movable jaw to provide the latter with a vertical movement.

According to a first embodiment of the invention, the head supporting the movable jaw is mounted freely in rotation on an eccentric given in rotation about a central axle fixed in vertical position of the piston of said jack located below.

According to a second embodiment of the invention, the head supporting the movable jaw is mounted fixedly on an axle prolonging the piston rod of the jack whose cylinder is constituted by the eccentric.

According to a third embodiment of the invention, the head is mounted turnably on the eccentric which is driven in rotation by a grooved member and positioned vertically by the piston of the jack.

According to a fourth embodiment of the invention, the head is mounted freely in rotation on the eccentric turning about a central fixed axle and can slide vertically by means of a jack whose cylinder is disposed on the central fixed axle and whose piston is secured to the head.

The invention will be better understood from the examples of embodiment shown in the accompanying drawings, in which:

FIGS. 1 to 4 show crushers of the prior art, explained above.

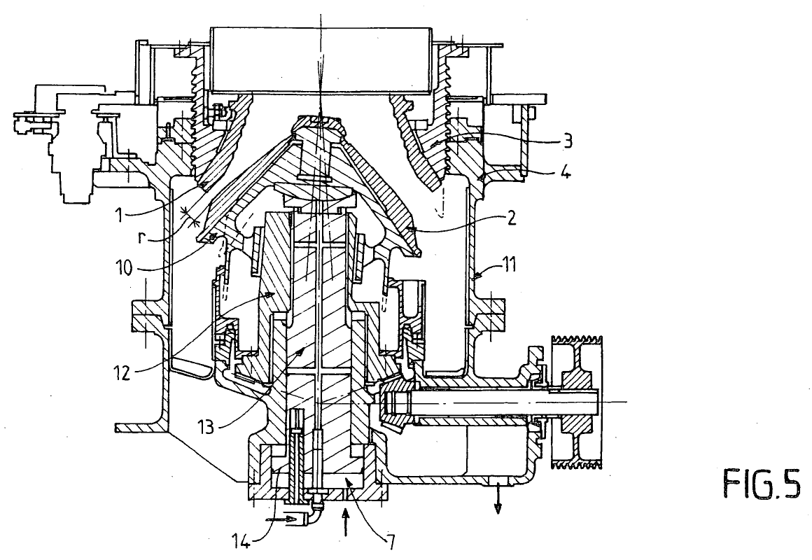

FIG. 5 shows a first embodiment of the invention.

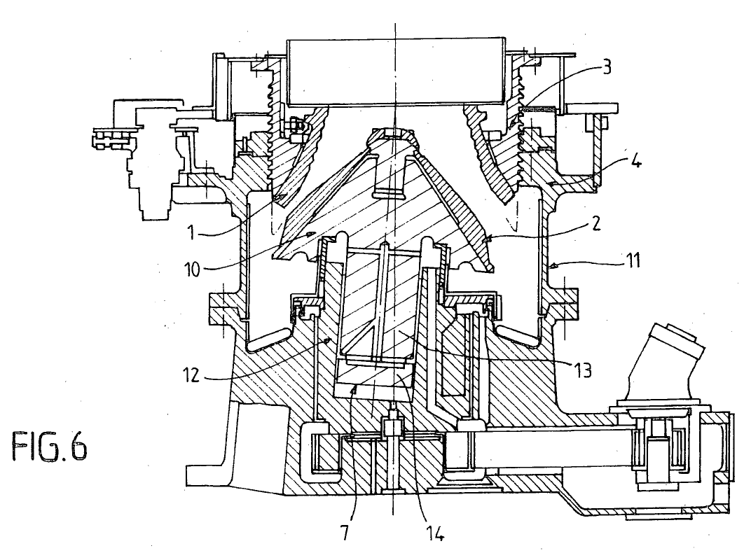

FIG. 6 shows a second embodiment of the invention.

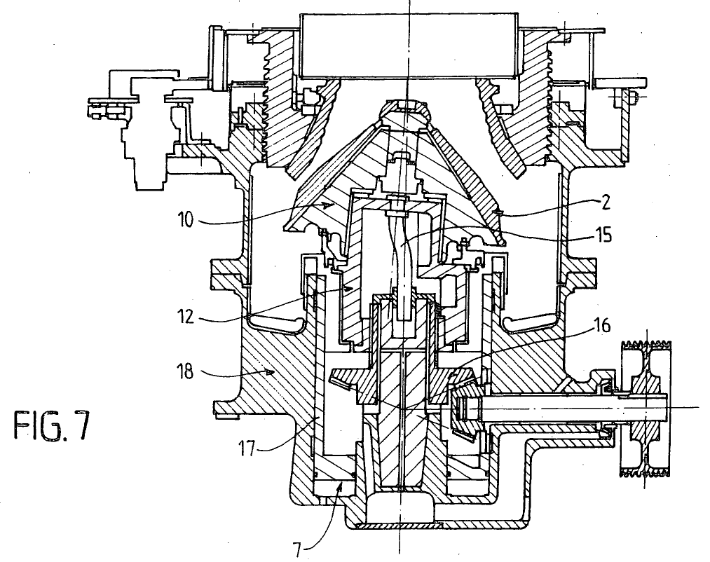

FIG. 7 shows a third embodiment of the invention.

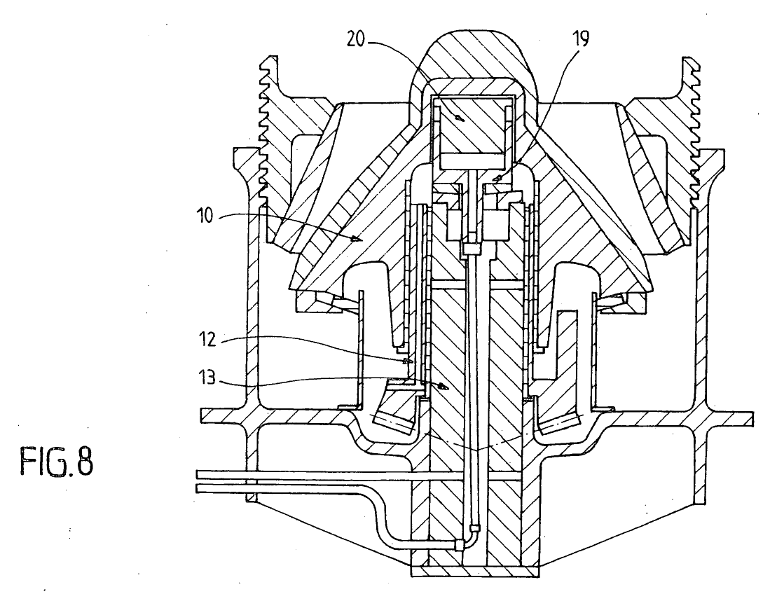

FIG. 8 shows a fourth embodiment of the invention.

The embodiment shown in FIG. 5 shows a crusher whose fixed jaw 1 is fixed to a bowl 3 of external cylindrical shape, mounted movably in vertical translation in a portion 4 of corresponding shape of the frame 11. The means for moving the bowl 3 are constituted in this example by a screw thread on the envelope of the bowl, permitting screwing it into a tapped bore of the portion 4 of the frame 11.

The head 10 carrying the movable jaw 2 is disposed on the upper end of a central vertical axle 13, so as to be able to oscillate relative to the latter and is driven in nutation by a drive eccentric 12, itself driven by a motor (not shown) to turn about the axle 13.

The central axle 12 is constituted by the rod of the piston 14 of a jack 7 located below the axle and provided with hydraulic liquid by a pump and accumulators (not shown).

The operation of the crusher is the following:

Before crushing, the bowl 3 carrying the fixed jaw 1 is moved in vertical translation by screwing the bowl 3 in the portion 4 of the frame 11 until the spacing r between the jaws is adjusted to the desired granulometry. This adjustment of the spacing includes the compensation of the overall wear if the jaws have already been used.

When the crusher is loaded, the head 10 carrying the movable jaw 2 is driven by the eccentric 12 which itself gives a nutatory movement to the open end of the axle 13.

The piston 14 being, at the beginning of operation, being disposed at about mid-course in the cylinder of the jack 7, receives, by means of the axle 13, the pressure exerted on the head 10. If, because of uncrushable material, this pressure increases abruptly and becomes greater than that provided to the accumulator (not shown), the piston 14 descends and thus lowers the crushing head 10, thereby increasing the spacing between the jaws 1, 2. The uncrushable material can pass the jaws and fall out.

When, because of wear, the spacing between the jaws increases, the detection of this variation of spacing gives rise to the movement of the piston 14 of the jack 7 upwardly, automatically with a control or manually by surveillance of the amount of the spacing 4, thereby bringing the movable jaw 2 toward the fixed jaw 1.

In the example of embodiment shown in FIG. 6, in which the identical portions or those playing the same role bear the same reference numerals, the axle 13 carrying the head 10 slides in the eccentric 12 along an axis inclined relative to the vertical. The head 10 is fixed relative to the axle 13 and its nutatory movement is ensured by its inclination relative to the vertical.

The eccentric 12 is driven in rotation by means of gearing not identified by reference numeral. This drive can take place by a belt or a chain, or by another means for transmission such as the hydraulic motor shown.

The initial adjustment of the spacing and the compensation for overall wear, take place in the same way as in the preceding example.

In the course of work, the piston 14 secured to the axle 13 is actuated by the pressure in the jack 7 and moves the head 10 in one direction or the other so as to adjust the spacing between the jaws.

The example of FIG. 7 differs from the preceding in that the head 10 carrying the movable jaw 2 has no axle 13 but is mounted, being able to turn independently of the latter, on the eccentric 12, this latter being driven in rotation by a channeled member 16 on which is can slide. The eccentric head assembly is positioned vertically by the piston 17 of the jack 7 sliding in the frame 18, this permitting the adjustment of the machine.

FIG. 8 shows the preferred version of the invention.

The upper portion (not shown) can be identical to the preceding examples.

The eccentric 12 turns about the fixed axle 13 and gives a nutatory movement to the head 10, which is mounted freely in rotation about the eccentric 12. This head can also slide vertically on the eccentric 12 by means of a jack whose cylinder 19 is disposed on the fixed axle 13 and whose piston 20 is secured to the head 10, this permitting adjustment of the machine.

It follows that the invention can be embodied in other modifications without departing from the scope of the latter.

1. Cone crusher comprising a truncated conical crushing chamber whose wall supports a fixed jaw, and a conical head mounted on a shaft coaxial with the chamber and provided with an eccentric, which carries the movable jaw, the spacing between the fixed jaw and the movable jaw being adjusted by means of jacks, characterized in that the adjustment of the spacing r between the jaws (1, 3), including the compensation of overall wear, is carried out during stopping, before working, by means ensuring a vertical movement of the fixed jaw (1) relative to the frame (11), whilst the measures for adjustment, safety and compensation of daily wear are adjusted, during working of the crusher, by means of a jack (7) located below the movable jaw (2) to give this latter a vertical movement.

2. Cone crusher according to claim 1, characterized in that the head (10) supporting the movable jaw (2) is mounted freely in rotation on an eccentric (12) driven in rotation about a central axle (13) secured in vertical position of the piston (14) of said jack (7) located below.

3. Cone crusher according to claim 1, characterized in that the head (10) supporting the movable jaw (2) is mounted fixedly to an axle (13) prolonging the piston rod (14) of the jack (7) whose cylinder is constituted by the eccentric (12).

4. Cone crusher according to claim 1, characterized in that the head (10) is mounted turnably on the eccentric (12) which is driven in rotation by a channeled member (16) and positioned vertically by the piston (17) of the jack (7).

5. Cone crusher according to claim 1, characterized in that the head (10) is mounted freely in rotation on the eccentric (12) turning about a fixed central axle (13) and can slide vertically by means of a jack whose cylinder (19) is disposed on the fixed central axle (13) and whose piston (20) is secured to the head.
